(19) United States
(12) Patent Application Publication
(10) Pub. No.: US 2012/0245984 A1
(43) Pub. Date: Sep. 27, 2012

(54) SYSTEMS AND METHODS FOR ACQUIRING A CAPTIVE CUSTOMER BASE WITHIN A CLOUD ENVIRONMENT

(76) Inventor: Sungil Lee, San Jose, CA (US)

(21) Appl. No.: 13/052,935

(22) Filed: Mar. 21, 2011

(51) Int. Cl. G06Q 30/00

(52) U.S. Cl. 705/14.11

(57) ABSTRACT

In one example embodiment, a computer-implemented method for acquiring a captive customer base within a cloud computing environment comprises providing customer software to a service organization, with the customer software being configurable to facilitate communications between the service organization and a client base of the service organization. The customer software provided to the service organization is subsidized based on a condition that the service organization allows a software provider to embed context-based marketing content in the customer software, and is provided to the client base via the customer software, with the context-based marketing content directed to products offered by the software provider, and the products being supplemental to service organization services, thereby using the customer software to generate revenue for the software provider, with costs of the context-based marketing being determined by software development costs.

### FIELD

This application relates generally to data processing and more specifically to computer-implemented systems and methods for acquiring a captive customer base within a cloud environment.

### BACKGROUND

Traditional online marketing methods may involve selling products directly to users from an e-commerce site. The products may be advertised through a third party site with a large customer base. Examples of third party online advertising include contextual ads on search engine results pages, banner ads, Rich Media Ads, social network advertising, interstitial ads, online classified advertising, advertising networks and e-mail marketing, including e-mail spam. To reach a bigger customer base, the advertisement budget must be increased. In order to maximize the profits, additional advertisement costs must be offset by the resulting additional revenues.

A service organization (e.g., a school) may need new communication tools to keep providing basic services to their customer base. However, the service organization may lack funds to acquire these services and, therefore, is forced to engage in direct solicitation, special events (e.g., a walkathon), or products sales (e.g., cookie sales). These activities require active involvement of the service organization with its customer base.

Cloud-based online systems have been increasing in popularity because they allow using computation, software, data access, and storage services that do not require end-user knowledge of the physical location and configuration of the system that delivers the services. A cloud-based computing environment may provide the perfect tools for the service organization's needs and create opportunities for new marketing methods.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

In an example, a method for acquiring a captive customer base within a cloud computing environment comprises providing customer software to a service organization, with the customer software being configurable to facilitate communications between the service organization and a client base of the service organization, wherein the customer software provided to the service organization is subsidized based on a condition that the service organization allows a software provider to embed context-based marketing content in the customer software, and providing to the client base via the customer software, the context-based marketing content directed to products offered by the software provider, with the products being supplemental to service organization services, thereby using the customer software to generate revenue for the software provider, with the costs of the context-based marketing being determined by the software development costs.

The customer software may be marketed directly to the service organization in order to capture the client base through the service organization. The products offered by the software provider may include goods, services, and subscriptions. The context-based marketing may not conflict with interests of the service organization. The context-based marketing may be dynamically provided by the software provider. The customer software is provided by the software provider to the service organization free of charge. The customer software may be educational software designed to supplement in-class instructions or to supplement in-person tutoring to the client base. The customer software may be periodically provided to new members of the client base. The marketing audience may be expanded by providing the customer software to a new service provider. Each new member of the service organization may be automatically added to the client base. A security protection of the client base may be established by encoding information related to the client base.

The method may further comprise acquiring further captive customer bases by offering the customer software to further service organizations having further client bases, and each customer of the further client bases may become a captive customer of the software provider, with the incremental costs associated with acquiring each of the further client bases decreasing, thereby making the method more profitable.

In further examples, the steps of the above method are stored on a machine-readable medium comprising instructions, which, when implemented by one or more processors, perform the steps. In yet further examples, subsystems or devices can be adapted to perform the recited steps. Other features, examples, and embodiments are described below.

### BRIEF DESCRIPTION OF DRAWINGS

Embodiments are illustrated by way of example and not limitation in the figures of the accompanying drawings, in which like references indicate similar elements and in which:

FIG. 1 is a block diagram illustrating a client base of a service organization within a cloud server environment, in accordance with an example embodiment.

FIG. 2 illustrates a traditional break-even analysis with marketing costs increasing with revenues.

FIG. 3 illustrates a break-even analysis with fixed costs development and the increase in sales revenue by capturing more captive customer bases, in accordance with an example embodiment.

FIG. 4 is a block diagram illustrating a network environment within which systems and methods for acquiring a captive customer base within a cloud environment are implemented, in accordance with an example embodiment.

FIG. 5 illustrates a software interface, in accordance with an example embodiment.

FIG. 6 is a block diagram illustrating a cloud environment within which systems and methods for acquiring a captive customer base are implemented, in accordance with an example embodiment.

FIG. 7 illustrates a process flow diagram illustrating a method for acquiring a captive customer base within a cloud environment, in accordance with an example embodiment.

FIG. 8 is a diagrammatic representation of an example machine in the form of a computer system, within which a set of instructions for causing the machine to perform any one or more of the methodologies discussed herein may be executed.

### DETAILED DESCRIPTION

Systems and methods for acquiring a captive customer base within a cloud environment may provide new ways of capturing a large customer base for selling subscriptions or products.

The cloud environment has created new opportunities in marketing. Traditionally, products are either sold directly to the end user or provided free of charge with revenues being generated by accompanying promotions. In order for the marketing to generate sufficient revenue and offset the costs of the product development, the customer base should be sufficiently large, and, correspondingly, the cost of acquiring the customer base tends to be large. The new systems and methods may allow marketing of goods and services to the customer base of a service organization by embedding marketing promotion within the software provided to the service organization wherein the cost of acquiring the customer base does not grow with the customer base.

The following description and drawings are illustrative and are not to be construed as limiting. Numerous specific details are described to provide a thorough understanding. However, in certain instances, well known or conventional details are not described in order to avoid obscuring the description. References to one or an embodiment in the present disclosure are not necessarily references to the same embodiment, and such references mean at least one.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described, which may be requirements for some embodiments but not other embodiments.

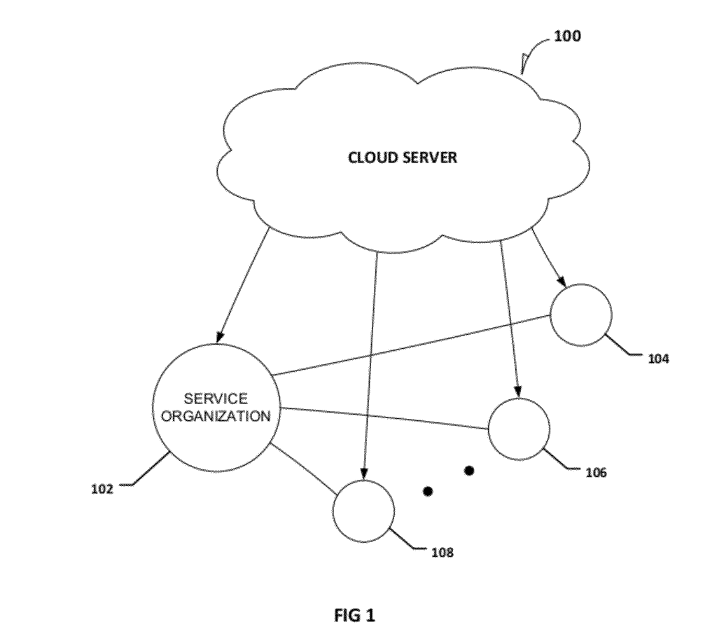

FIG. 1 is a block diagram illustrating a client base of a service organization within a cloud server environment. As shown in FIG. 1, a cloud server 100 may connect a service organization 102 with clients 104, 106, and 108. For example, a school may have classes of students connected and serviced by their respective teachers. A tutoring school may have a large number of parents and students as clients. A real estate broker may have a large client base. A church may have a large number of members. Thus, the service organization 102 may have a large number of clients such as the clients 104, 106, and 108. The number of clients in each client base may be an important factor in the marketing methods described herein. The client server 100 may keep track of all client information, activities, and scheduling by using subsidized software provided by the software provider. In exchange for providing free software, the software provider receives access to the service organization client base. The software provider can then offer products to the client base. The products will not conflict with the services offered by the service organization 102 (for example, the software provider may offer supplementary software).

Thus, free or low cost software may be provided to the service organization 102 that facilitates services provided by the service organization 102 to its customer base. For example, the software may help a teacher to connect with students and their parents in the cloud environment. This software may provide for participation by the students and parents, such as the completion and grading of homework and as a forum for discussions. The software may be provided free of charge in exchange for allowing the software provider to promote other products and services to the students and parents joined in this cloud environment. Each teacher who uses this free software may have 40 to 60 clients involved in this service cloud. For this client base, products may be offered for sale.

In the case of a school, teachers tend to use software once it is adopted. Because students and their parents have to use the software chosen by the school, this is an excellent way to keep existing customers. Every year, new students and their parents join the client base and use the customer software. Once the client base is captured, it is retained for as long as the service organization continues using the software. In contrast, in a typical marketing environment, a customer is free to be a one-time buyer and must be reacquired for another purchase. This is one of the reasons why the cost of promoting a product in a traditional online marketing environment is much higher. The quality of the customers is excellent and because the products are marketed within a captive market, there is no competition from other providers. The retention rate is excellent since the service organization 102, not the customer, makes the decision to keep using the software. As new customers join the service organization, they become available for the marketing of products within the same captive market. Critical information associated with the clients may be encrypted so that it cannot be viewed by a third party and/or software provider employees.

In case of a school, supplemental educational products may be offered to a teacher's clients. If the service organization is a church, the software may be provided within the cloud environment where all church members are users of the software. Any products that supplement church activities may be offered in this cloud environment. Thus, a method for acquiring a captive customer base within a cloud environment may facilitate capturing the client base of a service organization. This customer base may represent a captive market for the software provider where the clients have only one supplier, and, therefore, their only choice is to purchase what is available or to make no purchase at all. This captive market can be expanded to additional client bases by supplying the software to further service organizations. The cost of software will be similar to that of a typical software development; however, the marketing costs associated with capturing client bases will not increase considerably with additions of new service organizations. As a result, the revenues will grow while expenses will be substantially fixed.

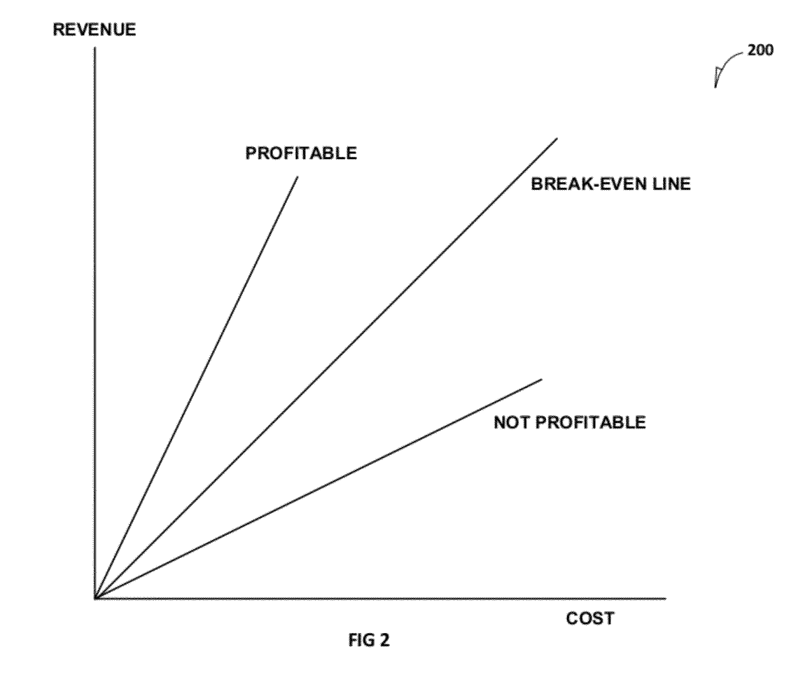

FIG. 2 illustrates a traditional break-even analysis 200 with marketing costs increasing as the revenues increase. As shown, the revenues generated by product promotion must exceed the costs associated with the promotion in order for a marketing campaign to be successful. In other words the revenue must exceed the amount it takes to break even with the costs of the promotion at all times. Oftentimes, additional funds spent on promotion do not result in increased profits. On the contrary, when costs associated with the promotion increase faster than revenues, the business model fails.

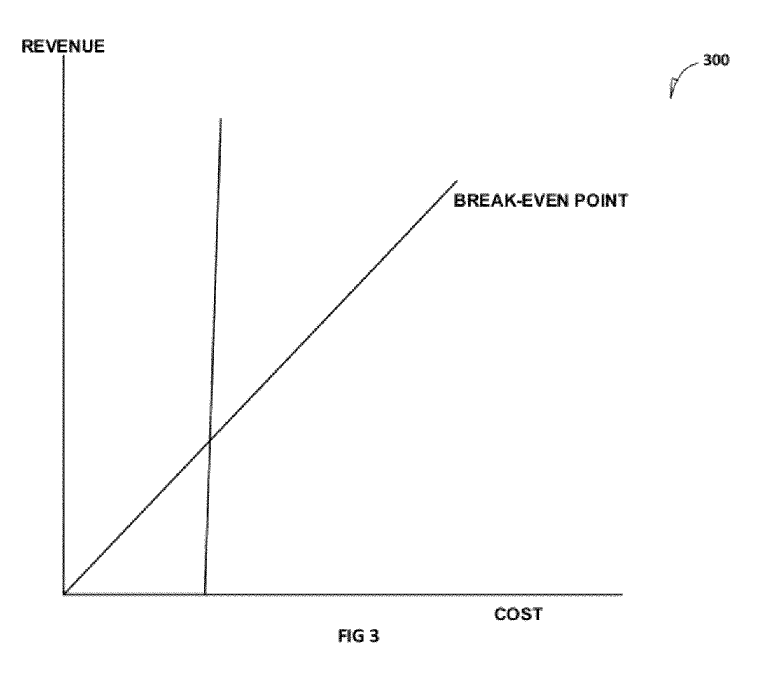

In contrast, FIG. 3 illustrates a break-even analysis 300 with marketing costs being fixed by software development costs, in accordance with an example embodiment. As shown in FIG. 3, the cost of creating software for a service organization can be predicted and relatively constant, increasing only slightly with each additional client base. However, the revenues increase rapidly with each addition of a new client base because of the multiplication factor associated with each service organization. This marketing method is made possible by a cloud computing environment. The use of the software by the service organizations is greatly facilitated by data sharing and network communication capability under a cloud environment.

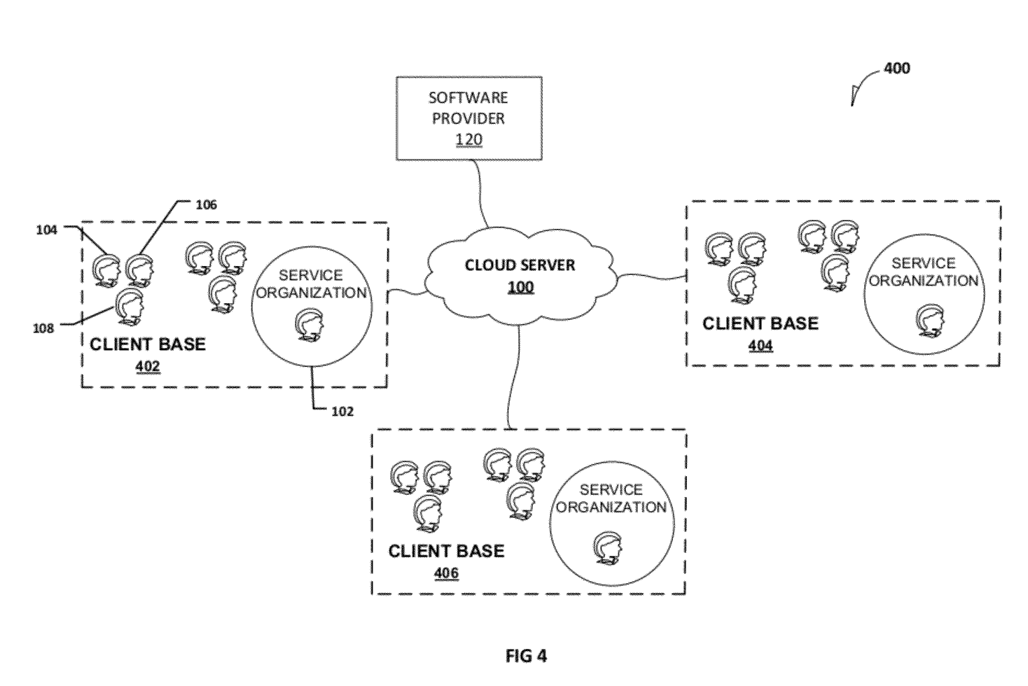

FIG. 4 is a block diagram illustrating a network environment 400 within which systems and methods for acquiring a captive customer base within a cloud environment may be implemented. The service organization 102 may already use customer software provided by the software provider 120 to engage its client base 402. The use of such software may be mandatory or optional. For example, if the service organization 102 is a school, a schoolteacher within the service organization 102 may use educational software to supplement in-class instruction. Such software may facilitate completing various educational and organizational tasks by the teachers; setting due dates for assigned homework in a class; grading; notifying school staff of events; facilitating communications between teachers, students, and parents; clarifying homework assignment;, facilitating parent support of student activities; and helping to provide more supplemental materials for learning. A tutoring center may use online tutoring software to supplement in-person tutoring. A real estate brokerage may use real estate software to provide new real estate listings to its clients.

According to the present systems and methods, the software may be provided to the service organization 102 free of charge on the condition that the service organization allows the embedding of context-based marketing in the software. For example, various products that supplement church activities may be offered in the software used by a church. This approach may allow the service organization to use free software while the provider receives revenue from marketing context-based goods and services to the client base 402.

According to a traditional marketing model, the costs of marketing increase with the increase in the target audience. Oftentimes, the costs of marketing increase faster than the revenues, which results in the failure of the marketing campaign. In contrast, the present systems and methods allow the cost of the software development to determine the cost of the marketing, and the revenues increase with an increase in the number of service organizations utilizing the software. As a result, the costs of the marketing are fixed, and the break-even point is reached faster.

The cloud server 100 may use a distributed system architecture of the software systems involved in the delivery of cloud computing, which typically involves multiple cloud components communicating with each other over application programming interfaces, web services and multi-tier architecture. The cloud architecture may include a front end and a back end, which are not necessarily arranged as traditional client-server architecture with a monolithic server. Instead, the cloud architecture may include a client's network (or computer) and the applications used to access the cloud via a user interface (such as a web browser). The back end of the cloud architecture may include a distributed data center comprising various computers, servers and data storage devices. Because the cloud architecture is a distributed system architecture, communications between multiple cloud components are generally asynchronous and are triggered by predetermined events.

In the case of a school, the teacher can use the software without having to worry where the server is, how the service is provided, and/or how the network is connected. The teacher becomes just a user, and a homework assignment and other information can be shared by all parties. The teacher may send a notice to parents to download this software (in case of the desktop version) to receive the grades, assignments, homework and other information. Within the software, the software provider may offer additional services such as, for example, daily practices in mathematics and additional lesson subjects, for a fee (e.g., $3, $5). In another example, a child may be reading about Napoleon, and then download and take a quiz for a fee.

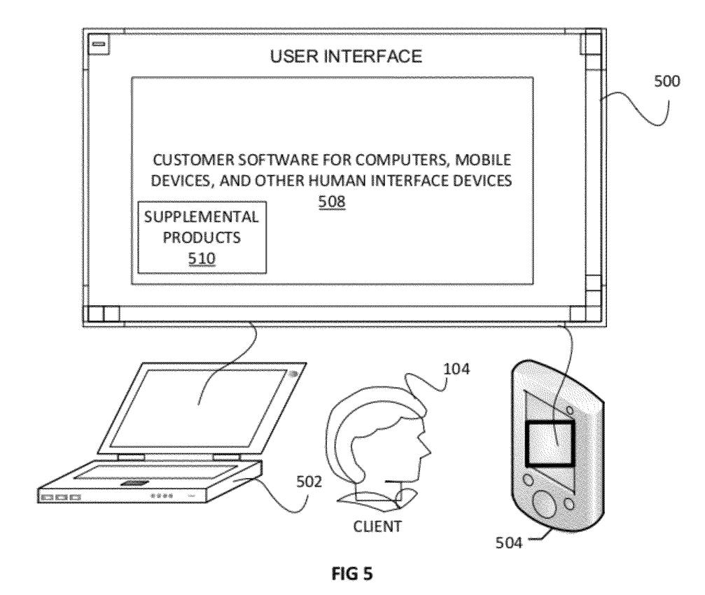

FIG. 5 illustrates a user interface 500, in accordance with an example embodiment. The user interface 500 may include customer software 508 and supplemental products 510. The customer software 508 may be provided to the client 104 free of charge through a service organization, but the supplemental product 510 may be provided for a fee. The supplemental product 510 may be installed on a computer 502 or a mobile device 504 by the client 104. The supplemental product 510 may be cloud-based software that is activated within the user interface 500 upon payment of a fee. The customer software 508 may include software for computers, mobile devices, and other human interface devices. The computer 502 and mobile device 504 may include tablet-type devices. Tablet-type devices may come in multiple sizes but commonly include a complete personal mobile computer equipped with a touch screen and primarily operated by touching the screen. The mobile device 504 may run a cloud application relying on cloud computing for its support. The computer 502 and mobile device 504 may be cloud devices. Users of the computer 502 and the mobile device 504 may be unaware of the specifics of the server-end components with respect to their location, capacity, speed, and so forth. In some embodiments, the cloud environment may only include mobile devices or any other human interface in the form of a table-type device (e.g., iPad).

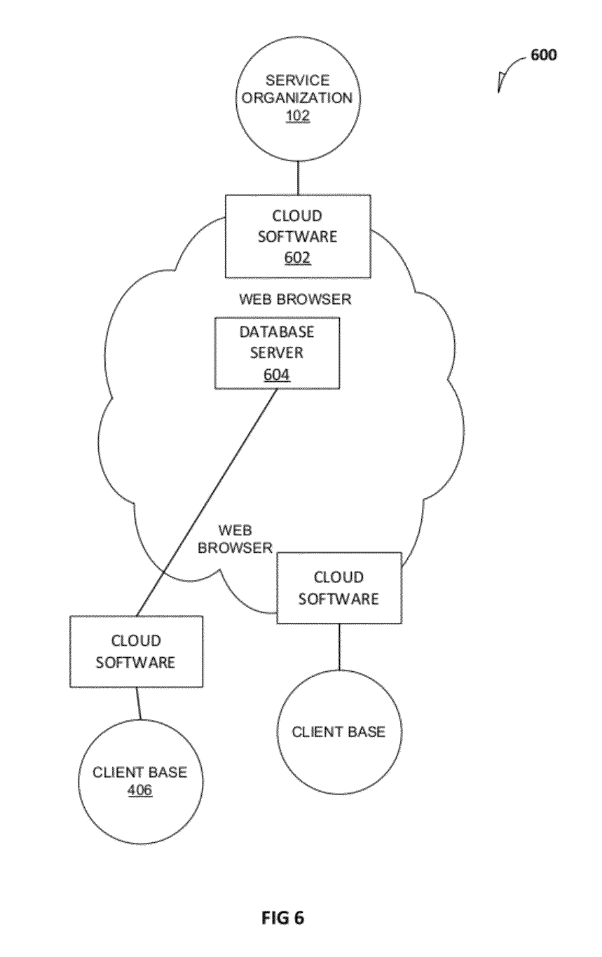

FIG. 6 is a block diagram illustrating a cloud environment 600 within which systems and methods for acquiring a captive customer base can be implemented. As shown in FIG. 6, the service organization 102 and the client base 406 may be connected by cloud software 602. The cloud software 602 may deliver software as a service over the Internet, eliminating the need to install and run the customer software 508 on the computer 502 of the client 104. This simplifies maintenance and support and also allows centralized feature updating, which obviates the need for downloadable patches and upgrades. The cloud software 602 may facilitate deployment of applications without the cost and complexity of buying and managing the underlying hardware and software layers.

A database server 604 may include a computer program that provides database services to the service organization 102, the client base 406, and the software provider 120. The database server 604 may be accessed either through a “front end” running on the user's computer, which displays requested data, or the “back end,” which runs on the server and handles tasks such as data analysis and storage.

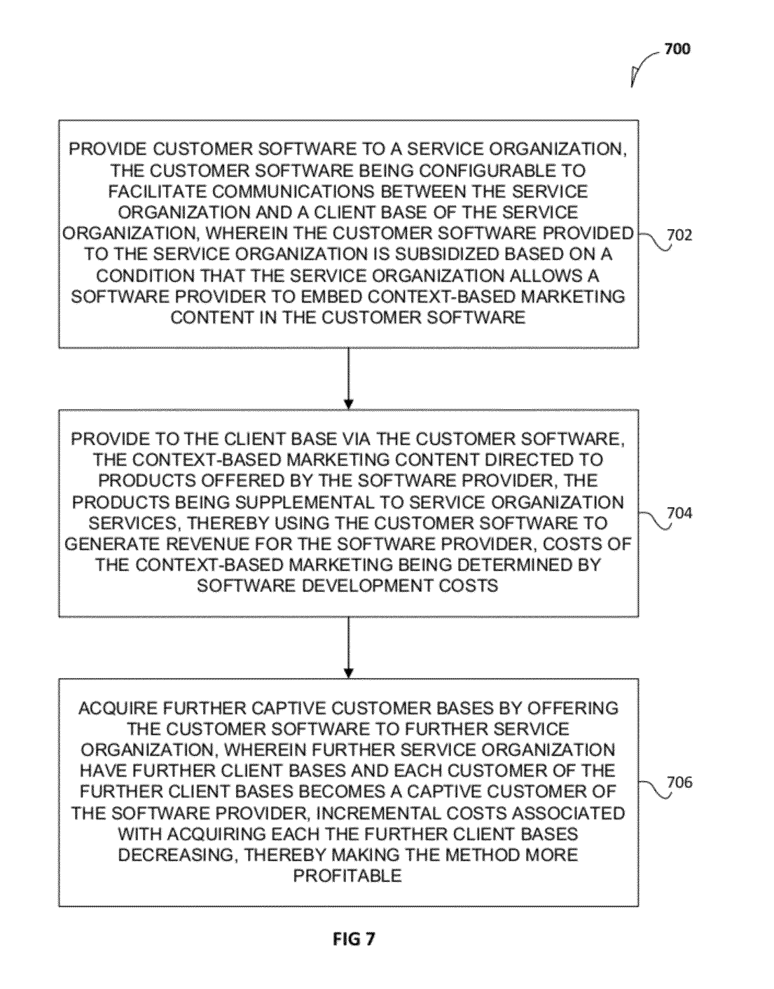

FIG. 7 is a process flow diagram illustrating an example method 700 for acquiring a captive customer base within a cloud environment. The method 700 may be performed by processing logic that may comprise hardware (e.g., dedicated logic, programmable logic, microcode, etc.), software (such as is run on a general-purpose computer system or a dedicated machine), or a combination of both. In one exemplary embodiment, the processing logic resides at the cloud server 100, as illustrated in FIG. 4. The method 700 may commence at operation 702 with the software provider 120 providing the customer software 508 to the service organization 120. The customer software 508 may be configurable to facilitate communications between the service organization 102 and the client base 402. The customer software 508 provided to the service organization 102 may be subsidized based on a condition that the service organization 102 allows the software provider 120 to embed context-based marketing content (e.g., supplemental product 510) in the customer software 508. The customer software 508 may be provided free of charge or at a low cost.

At operation 704, the software provider 120 may provide to the client base 406, via the customer software 508, the context-based marketing content (e.g., supplemental product 510) directed to products offered by the software provider 120. These products may be supplemental to the service organization services, thereby using the customer software to generate revenue for the software provider 120 while the costs of the context-based marketing are determined by software development costs. For example, if the customer software is educational software designed to supplement in-class instructions to the client base, the supplemental product may directed to the current instructional topics. The supplemental product 510 may include goods, services, and subscriptions but may not conflict with interests of the service organization 102. As new clients join the client based 102, the customer software 508 may be provided to the new members as part of their overall service organization experience.

At operation 706, the software provider 120 may acquire further captive client bases by offering the customer software 508 to additional service organizations. The cost associated with providing software to additional service organizations can be quite low because once the software is developed, only minor modifications may be needed to provide the software to expand the client base, even when the service organization provides different services.

Additional service organizations include client bases of their own and each of their clients becomes a captive customer of the software provider 120. Because additional software applications may be made by modifying the original software application, incremental costs associated with acquiring additional client bases will decrease since the cost of promotion is fixed and lower per unit with each subsequent service organization.

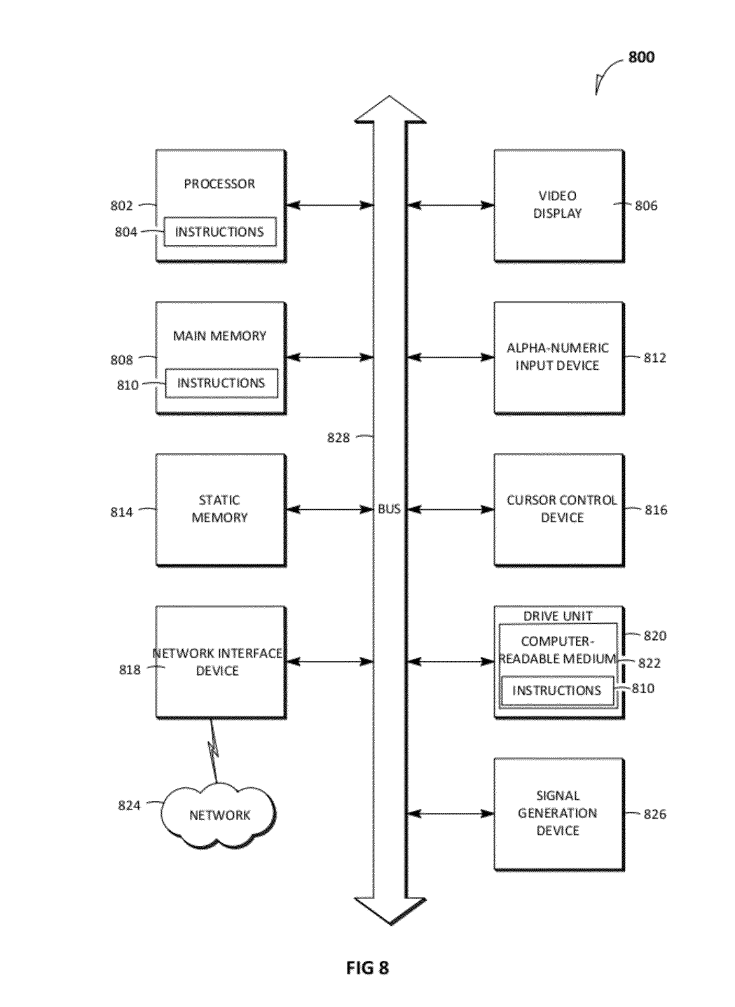

FIG. 8 is a diagrammatic representation of an example machine in the form of a computer system 800, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor or multiple processors 802 (e.g., a central processing unit (CPU), a graphics processing unit (GPU), or both), and a main memory 808 and static memory 814, which communicate with each other via a bus 828. The computer system 800 may further include a video display unit 806 (e.g., a liquid crystal display (LCD)). The computer system 800 may also include an alphanumeric input device 812 (e.g., a keyboard), a cursor control device 816 (e.g., a mouse), a voice recognition or biometric verification unit, a disk drive unit 820, a signal generation device 826 (e.g., a speaker) and a network interface device 818. The computer system 800 may further include a data encryption module (not shown) to encrypt data.

The disk drive unit 820 includes a computer-readable medium 822 on which is stored one or more sets of instructions and data structures (e.g., instructions 810) embodying or utilizing any one or more of the methodologies or functions described herein. The instructions 804 may also reside, completely or at least partially, within the main memory 808 and/or within the processors 802 during execution thereof by the computer system 800. The main memory 808 and the processors 802 may also constitute machine-readable media.

The instructions 810 may further be transmitted or received over a network 824 via the network interface device 818 utilizing any one of a number of well-known transfer protocols (e.g., Hyper Text Transfer Protocol (HTTP)).

While the computer-readable medium 822 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAMs), read only memory (ROMs), and the like.

The example embodiments described herein may be implemented in an operating environment comprising software installed on a computer, in hardware, or in a combination of software and hardware.

Thus, systems and methods for acquiring a captive customer base within a cloud environment have been described. Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

What I claim is:

1. A computer-implemented method for acquiring a captive customer base within a cloud computing environment, the method comprising:
providing customer software to a service organization, the customer software being configurable to facilitate communications between the service organization and a client base of the service organization, wherein the customer software provided to the service organization is subsidized based on a condition that the service organization allows a software provider to embed context-based marketing content in the customer software; and
providing to the client base via the customer software, the context-based marketing content directed to products offered by the software provider, the products being supplemental to service organization services, thereby using the customer software to generate revenue for the software provider, with costs of the context-based marketing being determined by software development costs.

2. The computer-implemented method of claim 1, wherein the customer software is marketed directly to the service organization to capture the client base through the service organization.

3. The computer-implemented method of claim 1, wherein the products offered by the software provider include one or more of the following: a good, a service, and a subscription.

4. The computer-implemented method of claim 1, wherein the context-based marketing content for the client base does not conflict with interests of the service organization.

5. The computer-implemented method of claim 1, wherein the context-based marketing is performed dynamically by the software provider.

6. The computer-implemented method of claim 1, wherein the customer software is provided by the software provider to the service organization free of charge.

7. The computer-implemented method of claim 1, wherein the customer software is educational software designed to supplement in-class instructions to the client base.

8. The computer-implemented method of claim 1, wherein the customer software is tutoring software designed to supplement in-person tutoring to the client base.

9. The computer-implemented method of claim 1, wherein the customer software is utilized by an educational organization such as a public school or a private school.

10. The computer-implemented method of claim 1, wherein the customer software is a religious organization providing one or more subscriptions to periodicals distributed via the customer software.

11. The computer-implemented method of claim 1, wherein the customer software is periodically provided to new members of the client base.

12. The computer-implemented method of claim 1, wherein a captive customer base is expanded by providing the customer software to a new service provider.

13. The computer-implemented method of claim 1, wherein each new member of the service organization is automatically added to the client base.

14. The computer-implemented method of claim 1, wherein a security protection of the client base is established by encoding information related to the client base.

15. The computer-implemented method of claim 1, wherein the client base has an exclusive marketing channel to the customer software.

16. The computer-implemented method of claim 1, further comprising acquiring further captive customer bases by offering the customer software to further service organizations, wherein the further service organizations have further client bases and each customer of the further client bases becomes a captive customer of the software provider, while incremental costs associated with acquiring of each the further client bases is zero or decreasing, thereby making the method more profitable.

17. The computer-implemented method of claim 1, wherein the context-based marketing content is provided via one or more of the following human interface devices: a mobile telephone, a mobile device, a smartphone, an Internet and multimedia-enabled smartphone, a personal digital assistant, a personal mobile computer, and a tablet computer.

18. A system for acquiring a captive customer base within a cloud computing environment, the system comprising:
at least one subsystem for providing customer software to a service organization, the customer software being configurable to facilitate communications between the service organization and a client base of the service organization, wherein the customer software provided to the service organization is subsidized based on a condition that the service organization allows a software provider to embed context-based marketing content in the customer software; and
at least one subsystem for providing to the client base, via the customer software, the context-based marketing content directed to products offered by the software provider, the products being supplemental to service organization services, thereby using the customer software to generate revenue for the software provider, with costs of the context-based marketing being determined by software development costs.

19. The system of claim 18, wherein the customer software is marketed directly to the service organization to capture the client base through the service organization.

20. The system of claim 18, further comprising at least one system for acquiring further captive customer bases by offering the customer software to further service organizations, wherein the further service organizations have further client bases and each customer of the further client bases becomes a captive customer of the software provider, with incremental costs associated with acquiring each the further client bases decreasing, thereby making the method more profitable.

21. A machine-readable medium comprising instructions for acquiring a captive customer base within a cloud computing environment, which when implemented by one or more processors, performs the following operations:
provide customer software to a service organization, the customer software being configurable to facilitate communications between the service organization and a client base of the service organization, wherein the customer software provided to the service organization is subsidized based on a condition that the service organization allows a software provider to embed context-based marketing content in the customer software; and
provide to the client base, via the customer software, the context-based marketing content directed to products offered by the software provider, the products being supplemental to service organization services, thereby using the customer software to generate revenue for the software provider, with costs of the context-based marketing being determined by software development costs.
